(19) United States
(12) Patent Application Publication
(10) Pub. No.: US 2013/0083078 A1
(43) Pub. Date: Apr. 4, 2013

(54) Method and Apparatus for Presenting a Video Screen

(71) Applicant: Tencent Technology (Shenzhen) Company Limite, Shenzhen (CN)

(72) Inventors: Qiang Dai, Shenzhen (CN); Huateng Ma, Shenzhen (CN); Shiping Li, Shenzhen (CN)

(73) Assignee: TENCENT TECHNOLOGY (SHENZHEN) COMPANY LIMITED, Shenzhen (CN)

(21) Appl. No.: 13/686,653

(22) Filed: Nov. 27, 2012

Related U.S. Application Data
(63) Continuation of application No. PCT/CN2011/078749, filed on Aug. 23, 2011.

(30) Foreign Application Priority Data
Aug. 24, 2010 (CN) 201010261762.9

(51) Int. Cl. G06T 3/40

(52) U.S. Cl. CPC G06T 3/40
USPC 345/660

(57) ABSTRACT

Embodiments provide a method and an apparatus for presenting a video screen, which may identify a black border area in a video displaying interface and zoom an effective video displaying area in an original effective video screen to adjust the black border area intelligently. The black border area may include a black border area from an original video and a black border area of a displaying interface. Thus the effective video displaying area in the video displaying interface can be adjusted, a displaying area in a video screen can be adaptively adjusted, the black border area of the video screen can be eliminated without participation of a user, and diversified demands of users for video screens can be satisfied.

### RELATED DOCUMENT INFORMATION

This application is a continuation application of pending International Application PCT/CN2011/078749, filed on Aug. 23, 2011, which claims priority to Chinese Patent Application 201010261762.9, filed on Aug. 24, 2010, all of which are incorporated by reference in their entireties to the extent there is no inconsistency with the present disclosure.

### FIELD OF THE INVENTION

The present invention relates to video processing, and particularly, to a method and an apparatus for presenting a video screen.

### BACKGROUND

Currently, many videos have black borders on screens presenting the videos. As shown in FIG. 1, some video screens have black border areas at all four borders, and some video screens have black border areas at their upper and lower borders. The black border area refers to a redundant fixed area in black or in other colors outside the border of an effective video displaying area presenting a video on a video screen. The display effect of the video will not be affected if the fixed black border area is removed. As shown in FIG. 1, area 1 is an effective video displaying area presenting effective video information, and deletion of area 1 will make the video screen incomplete; area 2 is a black border area.

A black border area may include a black border from an original video and a black border of a video displaying screen. The black border from an original video refers to an ineffective displaying area which is located outside a video playing area and is generated during production of the video due to differences in video producing tools, technical levels, and producers and so on. The black border of a video displaying screen refers to a black border generated due to inconsistency between the size of the effective video displaying area and the size of the video displaying screen when the video is being played. For example, current video displaying interfaces may generally have aspect ratios of 4:3, 16:9, 16:10, while effective video screens generally have aspect ratios of 4:3 and 16:9. If the aspect ratio of the effective video screen is different from that of the video displaying interface, the video screen may have black borders when presented. With developments in the 3rd generation of communications, it has become more and more popular to view videos on mobile terminals. Since mobile terminals have diversified aspect ratios, e.g. 2:3, 9:16, 3:4, 3:5 and so on, black borders are more often seen on mobile terminals during video playing.

### SUMMARY

An embodiment of the present invention provides a method for presenting a video screen which may adaptively adjust a displaying area of a video screen and remove black border areas of video screens without participation of users.

An embodiment of the present invention provides an apparatus for presenting a video screen which may adaptively adjust a displaying area of a video screen and remove black border areas of video screens without participation of users.

In order to achieve the above objectives, the technical scheme of the present invention is as follows.

A method for presenting a video screen may include:

identifying a black border area in a video displaying interface;

zooming a video screen according to the black border area identified;

displaying the zoomed video screen in the video displaying interface.

A method for presenting a video screen may include:

an identifying module, configured to identify a black border area in a video displaying interface;

a zooming module, configured to zoom a video screen according to the black border area identified;

a displaying module, configured to display the zoomed video screen in the video displaying interface.

A non-transitory computer readable storage medium storing one or more programs, the one or more programs comprising instructions, which when executed by one or more computers, cause the device to: identify a black border area in a video displaying interface, to zoom a video screen according to the black border area identified, and to display the zoomed video screen in the video displaying interface.

It can be seen from the above technical scheme that, the method and apparatus for presenting a video screen can identify a black border area in a video displaying interface, and zoom an effective video displaying area in an original video screen to adjust the black border area intelligently. The black border area may include a black border area from an original video and a black border area of a displaying interface. Thus the effective video displaying area in the video displaying interface can be adjusted. Therefore, adaptive adjust of a displaying area in a video screen is realized, the black border area of the video screen can be eliminated without participation of users, and diversified demands of users for video screens can be met.

### BRIEF DESCRIPTION OF THE DRAWINGS

In order to make the technical scheme of embodiments of the present invention more clearly, the following is a brief introduction of the drawings used in description of the embodiments. Obviously, the following drawings are merely some of the embodiments, and based on which other drawings can be obtained by those skilled in the art without doing any inventive work.

FIG. 1 is a schematic diagram illustrating a conventional video displaying interface.

FIG. 2 is a schematic diagram illustrating a conventional video displaying interface.

FIG. 3 is a flowchart illustrating a method for presenting a video screen according to an embodiment of the present invention.

FIG. 4(a) to FIG. 4(c) are schematic diagrams illustrating the principle of segmenting a selected image and identifying a black border area according to an embodiment of the present invention.

FIG. 5 is a flowchart illustrating a method for zooming a video screen according to an embodiment of the present invention.

FIG. 6(a) to FIG. 6(b) are schematic diagrams illustrating a video screen before and after being zoomed under a first zooming mode according to an embodiment of the present invention.

FIG. 7(a) to FIG. 7(b) are schematic diagrams illustrating a video screen before and after zooming under a second zooming mode according to an embodiment of the present invention.

FIG. 8(a) to FIG. 8(b) are schematic diagrams illustrating a video screen before and after zooming under a third zooming mode according to an embodiment of the present invention.

FIG. 9 is a schematic diagram illustrating a structure of an apparatus for presenting a video screen according to an embodiment of the present invention.

FIG. 10 is a schematic diagram illustrating a structure of an identifying module in an apparatus for presenting a video screen according to an embodiment of the present invention.

FIG. 11 is a schematic diagram illustrating a structure of a zooming module in an apparatus for presenting a video screen according to an embodiment of the present invention.

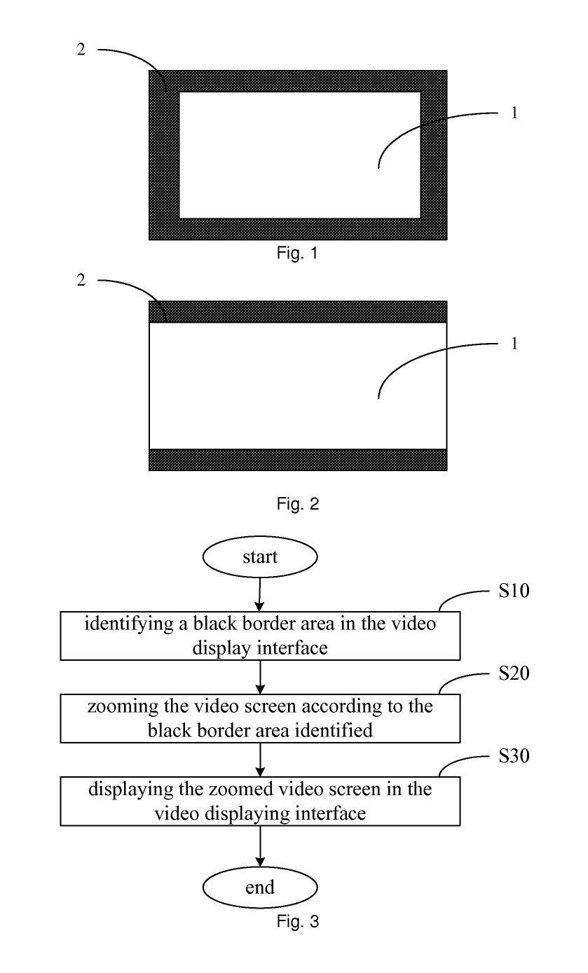

### EMBODIMENTS OF THE INVENTION

The present invention is hereinafter described further in detail with reference to the accompanying drawings so as to make the objective, technical solution and merits of embodiments more apparent. Obviously, the embodiments described are merely some of embodiments of the present invention, not all of the embodiments. Based on the embodiments of the present invention, other embodiments obtained by those skilled in the art without any inventive work done are still within the protection scope of the present invention.

At present, black border cropping tools are often adopted, which usually involves defining to-be-cropped black border areas manually, cropping the black border areas in video screens to generate a black-border-free new video file before playing the new video file. When the size of the effective video screen is inconsistent with the size of the video displaying interface, the zoom ratio of the screen may be manually adjusted to enlarge the video screen so that the black border areas is no longer within the displaying area of the video displaying interface and thus be hidden.

With regard to the black borders from original videos, cropping the black borders needs huge amounts of workload and the process is complex, and the need of processing video files using dedicated software tools also adds to the complexity and costs. Further, this manner can only handle black borders from original videos, and can not eliminate black border areas of the video displaying interface. Adjusting the zoom ratio manually may eliminate the black border areas of video displaying interfaces, but is not precise enough because it relies on manual fine tuning. The black border areas can not be adjusted in an intelligent manner, thus the operation is complex and requires users to control the zooming process of the video screens.

In order to remove a black border area in a video screen without participation of a user when a video is being played on a video displaying interface, an embodiment of the present invention adopts a method for adaptively adjusting a displaying area of a video screen, i.e. adjusting the black border area intelligently by identifying a black border area in a video displaying interface and zooming an original effective video playing area according to the black border area identified.

The video displaying interface refers to an interface displaying a video screen, the video screen refers to a displaying area not including the black border area, and the identified black border area may include a black border in an original video and a black border of the video displaying interface.

As shown in FIG. 3, the method for presenting a video screen may include the following procedures.

In block S10, a black border area in a video displaying interface is identified before a video screen is played on the video displaying interface.

In this block, the video played on the video displaying interface is composed of a video sequence. Each frame in the video sequence is an image. When a video includes video screens only, i.e. does not include a black border area, all of the contents of a frame is a video screen. When a video includes not only video screens but also black border areas, the black border areas in the video displaying interface should be identified at first to obtain the size of the video screen. The length and the height of the video screen are measured by pixels.

In an embodiment, the block 510 may include: selecting at least two frame images from the video sequence, scanning pixels in the at least two frame images, determining areas having the same pixels in the at least two frame images as the black border areas in the video displaying interface. In a preferred embodiment, three frames are randomly selected from the forepart, the medium part and the rear part of the video sequence respectively. Images of the three frames generally have big differences, thus the black border areas can be more precisely identified by scanning pixels in the three frames.

In an embodiment, the block S10 may also include: segmenting the selected at least two frame images into areas, scanning pixels in the areas, calculating a Hash value for pixels in each area, and identifying an area having the same pixels according to the Hash value. Although video screen contents of each two frames may be different, contents of the black border areas remain the same. Therefore, areas having the same pixels are the black border areas. For each image, black border areas only appear at the four borders, i.e. the upper border, the lower border, the left border and the right border. Therefore, only the four border areas of the video displaying interface are to be examined during the process of identifying the black border areas.

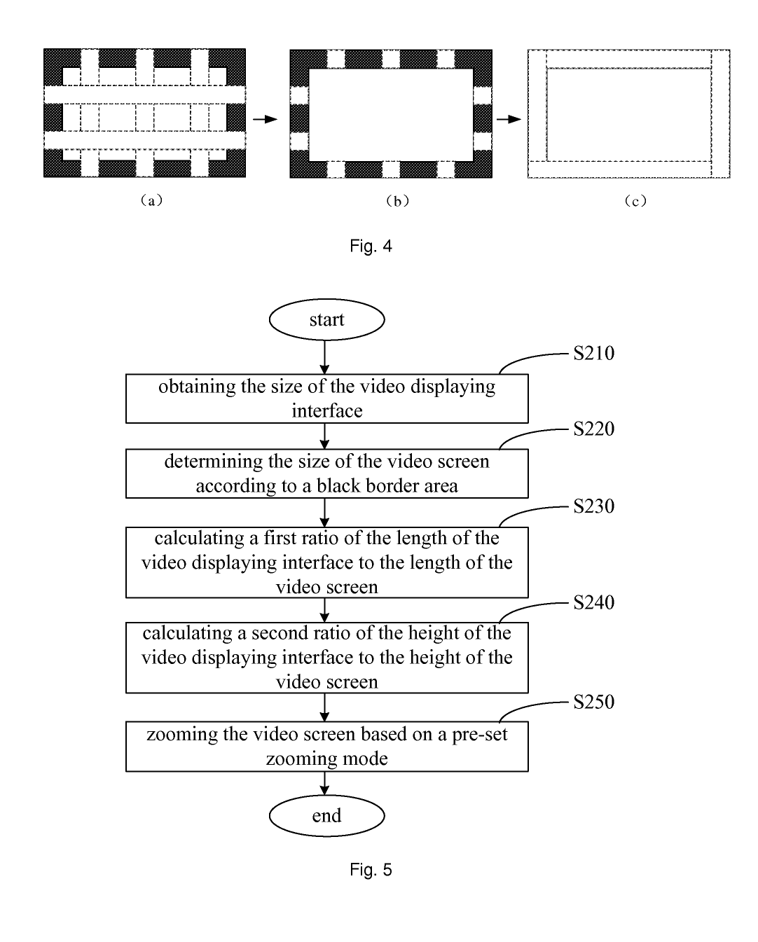

As shown in FIG. 4, rectangles drawn by dotted lines in FIG. 4(a) denote the areas segmented, and the areas have intersections with all the four border areas. Pixel scanning is performed for the area in each rectangle, and a Hash value is calculated for pixels in each area. If at least two selected frame images have the same Hash value, the frame images have the same pixels, thus areas having the same pixels can be identified in each frame based on the Hash value. The rectangles drawn by dotted lines in FIG. 4(b) are the identified areas having the same pixels. As shown in FIG. 4(c), the height in the vertical direction and the width in the horizontal direction of the areas having the same pixels are obtained to determine the four border areas of the video displaying interface as the black border areas identified.

Compared with scanning the whole area of the video displaying interface, scanning only the segmented areas reduces the total area to be scanned and improves the efficiency of identifying the black border areas in the video displaying interface.

In block S20, a video screen is zoomed according to the black border areas identified.

In an embodiment as shown in FIG. 5, the block S20 may include the following procedures.

In block S210, the size of the video displaying interface is obtained. The size of the video displaying interface may be determined according to the maximum area of a displaying screen or a player. The length and the height (or the width) of the video displaying interface may be measured by pixels.

In block S220, the size of the video screen is determined based on the black border areas.

Since the black border areas have been identified in the video displaying interface, the size of the video screen can be obtained by using the size of the video displaying interface.

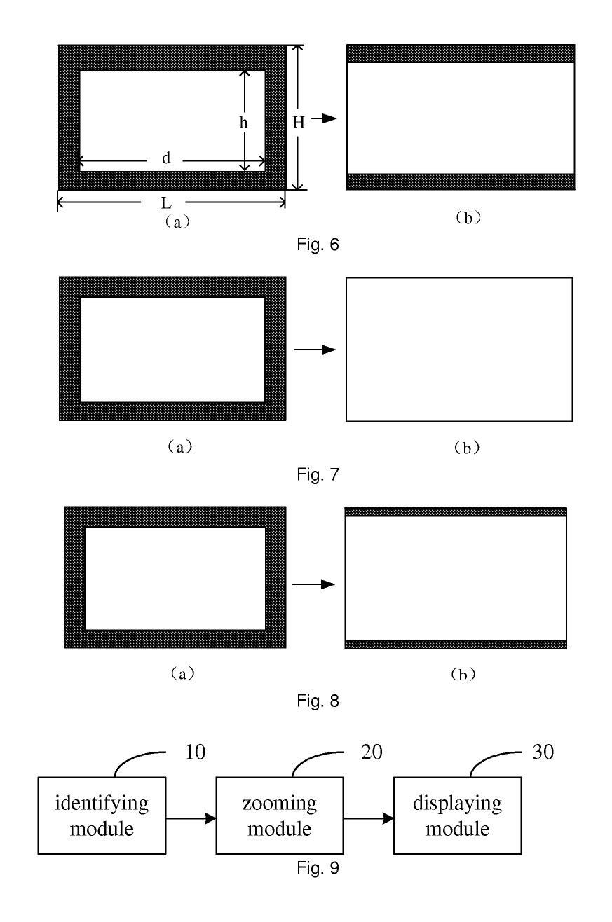

As shown in FIG. 6(a), the video displaying interface has a length of L, a height of H; the length of the video screen is d and the height is h according to the black border areas.

In block S230, a first ratio of the length of the video displaying interface to the length of the video screen is calculated. According to the above example, the first ratio obtained is L/d.

In block S240, a second ratio of the height of the video displaying interface to the height of the video screen is calculated. According to the above example, the second ratio obtained is H/h.

In block S250, the video screen is zoomed according to a pre-set zooming mode. In this embodiment, multiple zooming modes may be pre-set for the user to choose from. Different zooming modes may generate different video screens which are finally displayed on the video displaying interface, and the user may make a selection according to the needs.

A first zooming mode is a proportional deletion mode. When the first zooming mode is selected, the block S250 may include: selecting the smaller ratio of the first ratio and the second ratio, zooming the length and the height of the video screen according to the smaller ratio. As shown in FIG. 6, the smaller value of L/d and H/h is obtained, i.e. min (L/d,H/h). If the smaller one of the two ratios is the L/d, the length and the height of the video screen is zoomed in the proportion of L/d. As shown in FIG. 6(b), the black border areas at the left border and the right border of the video displaying interface are completely removed after the zoom procedure. Likewise, if the smaller one of the two ratios is the H/h, the length and the height of the video screen is zoomed in the proportion of H/f. The black border areas at the upper border and the lower border of the video displaying interface are completely removed after the zoom procedure, and this is not shown in the drawings.

A second zooming mode is a non-proportional complete deletion mode. When the second zooming mode is selected, the block S250 may include: zooming the length of the video screen in the proportion of the first ratio, and zooming the height of the video screen in the proportion of the second ratio. As shown in FIG. 7, the length of the video screen is zoomed in the proportion of L/d, and the height of the video screen is zoomed in the proportion of H/h. As shown in FIG. 7(b), after the zooming, the length of the video screen is the same with the length of the video displaying interface, the height of the video screen is the same with the height of the video displaying interface, and the black border areas are completed removed.

A third zooming mode is a proportional complete deletion mode. When the third zooming mode is selected, the block S250 may include: selecting the larger ratio of the first ratio and the second ratio, zooming the length and the height of the video screen according to the larger ratio. As shown in FIG. 8, the larger value of L/d and H/h is obtained, i.e. max (L/d, H/h). If the larger one of the two ratios is the L/d, the length and the height of the video screen is zoomed in the proportion of L/d. As shown in FIG. 8(b), the black border areas at the left border and the right border of the video displaying interface are completely removed after the zooming. Likewise, if the larger one of the two ratios is the H/h, the length and the height of the video screen is zoomed in the proportion of H/f. The black border areas at the upper border and the lower border of the video displaying interface are completely removed after the zooming, and this is not shown in the drawings.

In block S30, the zoomed video screen is displayed in the video displaying interface.

The above method for presenting a video screen zooms a to-be-played video screen according to black border areas identified in the video displaying interface, and intelligently adjusts the black border areas according to a zooming mode selected by a user. Thus, the above method can implement adjustment of a video screen in a video displaying interface and adaptive adjustment of a displaying area of a video screen, and can meet various requirements of users to video screens.

As shown in FIG. 9, an apparatus for presenting a video screen may include an identifying module 10, a zooming module 20 and a displaying module 30.

The identifying module 10 is configured to identify a black border area in a video displaying interface, and send information of the identified black border area to the zooming module 20.

The zooming module 20 is configured to zoom a video screen in the video displaying interface according to the black border area identified by the identifying module 10, and provide the zoomed video screen for the displaying module 30.

The displaying module 30 is configured to display the zoomed video screen provided by the zooming module 20 in the video displaying interface.

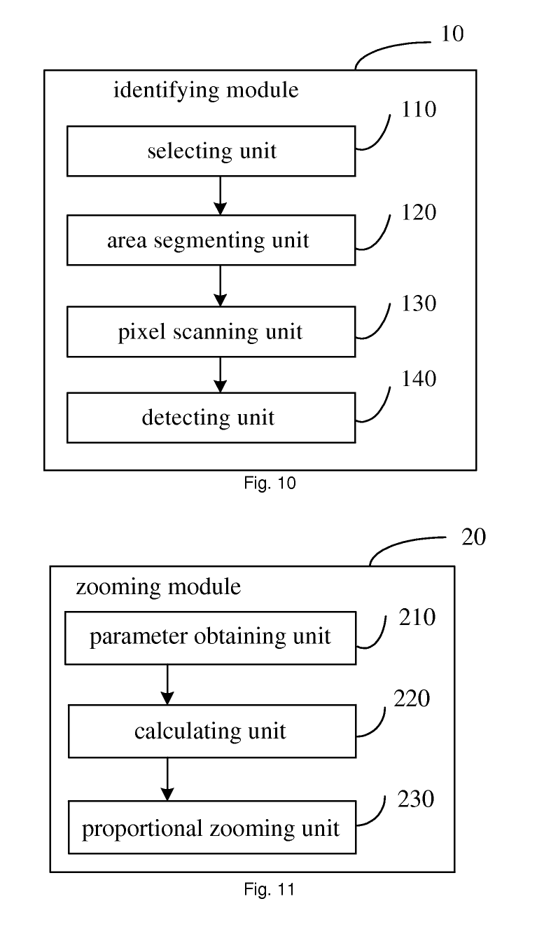

As shown in FIG. 10, in an embodiment, the identifying module 10 may include a selecting unit 110, an area segmenting unit 120, a pixel scanning unit 130 and a detecting unit 140.

The selecting unit 110 is configured to select at least two image frames from a video sequence to be played in the video displaying interface, and provide the at least two image frames for the area segmenting unit 120 and the pixel scanning unit 130.

In a preferred embodiment, the selecting unit 110 randomly selects three frames from the forepart, the medium part and the rear part of the video sequence. Images of the three frames generally have big differences, thus the black border areas can be more precisely identified by scanning the pixels in the three frames.

The area segmenting unit 120 is configured to segment the at least two image frames selected by the selecting unit 110 into areas and provide the areas to the pixel scanning unit 130. As shown in FIG. 4(a), the areas obtained are the rectangles enclosed by the dotted lines which have intersections with all four border areas of the video image. After the area segmentation, only pixels in the areas obtained are scanned, which can remarkably improve the efficiency of black border area identification.

The pixel scanning unit 130 is configured to perform pixel scanning for the at least two image frames selected by the selecting unit 110. Specifically, the pixel scanning unit 130 scans only the pixels in the areas obtained by the area segmenting unit 120, calculates a Hash value of pixels in each of the areas, identifies an area having the same pixels in each two frames when the area in the two frames have the same Hash value, and provides the area for the detecting unit 140.

The detecting unit 140 is configured to identify a black border area in the video displaying interface based on the area having the same pixels provided by the pixel scanning unit 130.

Since each image frame may have different effective video image contents but the black border areas always remain the same, an area having the same pixels in the selected at least two image frames is a black border area.

As shown in FIG. 11, in an embodiment, the zooming module 20 may include a parameter obtaining unit 210, a calculating unit 220 and a zooming unit 230.

The parameter obtaining unit 210 is configured to obtain the size of the video displaying interface, determine the size of the video screen based on the black border area identified, and provide the size of the video screen for the calculating unit 220. The length and the height of the video displaying interface may be denoted in unit of pixels, and are generally determined by the maximum area of the displaying screen or the player. The parameter obtaining unit 210 determines the size of the original effective video screen based on the black border area identified by the identifying module 10. As shown in FIG. 6(a), the length of the video displaying interface obtained by the parameter obtaining unit 210 is L, the height of the video displaying interface being H; the length of the video screen obtained by the parameter obtaining unit 210 is d and the height of the video screen is h.

The calculating unit 220 is configured to calculate a first ratio of the length of the video displaying interface to the length of the video screen. As shown in FIG. 6(a), the first ratio is L/d. The calculating unit 220 may further calculate a second ratio of the height of the video displaying interface to the height of the video screen. As shown in FIG. 6(a), the second ratio is H/h. The calculating unit 220 provides the first ratio and the second ratio for the proportional zooming unit 230.

The proportional zooming unit 230 is configured to zoom the video screen proportionally by using the first ratio and the second ratio provided by the calculating unit 220 based on a pre-set zooming mode.

There may be three candidate zooming modes.

A first zooming mode is a proportional deletion mode. When the first zooming mode is selected, the proportional zooming unit 230 is configured to select the smaller ratio of the first ratio and the second ratio, zoom the length and the height of the video screen according to the smaller ratio.

A second zooming mode is a non-proportional complete deletion mode. When the second zooming mode is selected, the proportional zooming unit 230 is configured to zoom the length of the video screen in the proportion of the first ratio, and zoom the height of the video screen in the proportion of the second ratio.

A third zooming mode is a proportional complete deletion mode. When the third zooming mode is selected, the proportional zooming unit 230 is configured to select the larger ratio of the first ratio and the second ratio, zoom the length and the height of the video screen according to the larger ratio.

The multiple modes are provided for the user to choose from, and different video screens may be obtained according to different user choices, therefore users' requirements can be fully satisfied.

All or part of contents of the technical schemes provided by the above embodiments may be implemented by software program. The software program may be stored in an accessible non-transitory storage medium. The storage medium may include a hard drive of a computer, a compact disk, or a floppy disk.

The foregoing are only preferred examples of the present disclosure and are not for use in limiting the protection scope thereof. All modifications, equivalent replacements or improvements in accordance with the spirit and principles of the present disclosure shall be included in the protection scope of the present disclosure.

1. A method for presenting a video screen, comprising:
identifying a black border area in a video displaying interface;
zooming a video screen according to the black border area identified;
displaying the zoomed video screen in the video displaying interface.

2. The method of claim 1, wherein the identifying a black border area in a video displaying interface comprises:
selecting at least two image frames from a video sequence to be played in the video displaying interface, scanning pixels in the at least two image frames, and identifying an area having identical pixels in the at least two image frames as the black border area in the video displaying interface.

3. The method of claim 2, wherein the scanning pixels in the at least two image frames and identifying an area having identical pixels comprise:
segmenting the selected at least two image frames into areas in the same way, scanning pixels in the same area of the at least two image frames, calculating a Hash value of pixels for the area in the at least two image frames, taking pixels having the same Hash value as the identical pixels;
obtaining the height of the identical pixels when the identical pixels are distributed horizontally in the video displaying interface, obtaining the width of the identical pixels when the identical pixels are distributed vertically in the video displaying interface, determining four border areas of the video displaying interface.

4. The method of claim 1, wherein the zooming a video screen according to the black border area identified comprises:
obtaining the size of the video displaying interface;
determining the size of the video screen based on the black border area;
calculating a first ratio of the length of the video displaying interface to the length of an original video screen, calculating a second ratio of the height of the video displaying interface to the height of the video screen;
zooming the video screen by using the first ratio and the second ratio based on a pre-set zooming mode.

5. The method of claim 4, wherein the zooming the video screen by using the first ratio and the second ratio based on a pre-set zooming mode comprises:
selecting the smaller ratio of the first ratio and the second ratio, zooming the length and the height of the video screen according to the smaller ratio.

6. The method of claim 4, wherein the zooming the video screen by using the first ratio and the second ratio based on a pre-set zooming mode comprises:
zooming the length of the video screen according to the first ratio, zooming the height of the video screen according to the second ratio.

7. The method of claim 4, wherein the zooming the video screen by using the first ratio and the second ratio based on a pre-set zooming mode comprises:
selecting a larger ratio of the first ratio and the second ratio, zooming the length and the height of the video screen according to the larger ratio.

8. An apparatus for presenting a video screen, comprising:
an identifying module, configured to identify a black border area in a video displaying interface;
a zooming module, configured to zoom a video screen according to the black border area identified;
a displaying module, configured to display the zoomed video screen in the video displaying interface.

9. The apparatus of claim 8, wherein the identifying module comprises:
a selecting unit, configured to select at least two image frames in a video sequence to be played in the video displaying interface;
a pixel scanning unit, configured to scan pixels in the at least two image frames and providing pixels scanned for a detecting unit;
the detecting unit, is configured to identify an area having identical pixels as the black border area in the video displaying interface.

10. The apparatus of claim 9, wherein the identifying module further comprises an area segmenting unit configured to segment the selected at least two image frames into areas; wherein the pixel scanning unit is further configured to scan pixels in an area segmented and to calculate a Hash value for the pixels in the area;
the detecting unit is configured to identify an area having identical pixels according to the Hash value.

11. The apparatus of claim 8, wherein the zooming module comprises:
a parameter obtaining unit, configured to obtain the size of the video displaying interface, and to determine the size of the video screen based on the black border area;
a calculating unit, configured to calculate a first ratio of the length of the video displaying interface to the length of an original video screen, to calculate a second ratio of the height of the video displaying interface to the height of the video screen;
a proportional zooming unit, configured to zoom the video screen proportionally by using the first ratio and the second ratio provided by the calculating unit based on a pre-set zooming mode.

12. The apparatus of claim 11, wherein the proportional zooming unit is further configured to obtain a smaller value of the first ratio and the second ratio, to zoom the length and the height of the video screen by using the smaller value as a zooming scale.

13. The apparatus of claim 11, wherein the proportional zooming unit is further configured to zoom the length of the video screen by taking the first ratio as a zooming scale and to zoom the height of the video screen by taking the second ratio as a zooming scale.

14. The apparatus of claim 11, wherein the proportional zooming unit is further configured to obtain a larger value of the first ratio and the second ratio, to zoom the length and the height of the video screen by using the larger value as a zooming scale.

15. A non-transitory computer readable storage medium storing one or more programs, the one or more programs comprising instructions, which when executed by one or more computers, cause the device to: identify a black border area in a video displaying interface, to zoom a video screen according to the black border area identified, and to display the zoomed video screen in the video displaying interface.

16. The computer readable storage medium of claim 15, comprising instructions that cause the one or more computers to: select at least two image frames from a video sequence to be played in the video displaying interface, scan pixels in the at least two image frames, and identify an area having identical pixels in the at least two image frames as the black border area in the video displaying interface.

17. The computer readable storage medium of claim 16, comprising instructions that cause the one or more computers to: segment the selected at least two image frames into areas in the same way, scan pixels in the same area of the at least two image frames, calculate a Hash value of pixels for the area in the at least two image frames, take pixels having the same Hash value as the identical pixels; obtain the height of the identical pixels when the identical pixels are distributed horizontally in the video displaying interface, obtain the width of the identical pixels when the identical pixels are distributed vertically in the video displaying interface, and determine four border areas of the video displaying interface.

18. The computer readable storage medium of claim 15, comprising instructions that cause the one or more computers to: obtain the size of the video displaying interface, determine the size of the video screen based on the black border area, calculate a first ratio of the length of the video displaying interface to the length of an original video screen, calculate a second ratio of the height of the video displaying interface to the height of the video screen; select the smaller ratio of the first ratio and the second ratio, and zoom the length and the height of the video screen according to the smaller ratio.

19. The computer readable storage medium of claim 15, comprising instructions that cause the one or more computers to: obtain the size of the video displaying interface, determine the size of the video screen based on the black border area, calculate a first ratio of the length of the video displaying interface to the length of an original video screen, calculate a second ratio of the height of the video displaying interface to the height of the video screen; zoom the length of the video screen according to the first ratio, and zoom the height of the video screen according to the second ratio.

20. The computer readable storage medium of claim 15, comprising instructions that cause the one or more computers to: obtain the size of the video displaying interface, determine the size of the video screen based on the black border area, calculate a first ratio of the length of the video displaying interface to the length of an original video screen, calculate a second ratio of the height of the video displaying interface to the height of the video screen; select a larger ratio of the first ratio and the second ratio, and zoom the length and the height of the video screen according to the larger ratio.
